(19) United States
(12) Patent Application Publication
(10) Pub. No.: US 2011/0072502 A1
(43) Pub. Date: Mar. 24, 2011

(54) Method and Apparatus for Identity Verification

(76) Inventors: Zhexuan Song, Silver Spring, MD (US); Ryusuke Masuoka, Potomac, MD (US)

(21) Appl. No.: 12/562,679

(22) Filed: Sep. 18, 2009

(51) Int. Cl. H04L 9/32; G06F 21/20; G06F 15/16

(52) U.S. Cl. 726/9; 709/206; 726/3; 726/5

(57) ABSTRACT

A method for identity verification includes receiving a request for proof of identity from a service provider and receiving biometric information associated with a user of a communication device. The method also includes determining that the received biometric information matches a biometric profile that contains biometric information associated with a registered user of the communication device. The method also includes unlocking a private key associated with the registered user in response to determining that the received biometric information matches a biometric profile and sending a request for a digital certificate that is signed with the private key associated with the registered user. The method further includes receiving the digital certificate that includes a public key associated with the registered user and satisfies the request for proof of identity. The method also includes with forwarding the digital certificate to the service provider.

### TECHNICAL FIELD

This disclosure relates in general to communication systems and more particularly to a method and apparatus for identity verification.

### BACKGROUND

When communicating over an unsecured public network, such as the Internet, it may be desirable to allow users to securely and privately exchange data. Such security may be particularly desirable when a user is requesting one or more services from a service provider, such as an online store or central document repository. Several methods exist to verify the identity of a user attempting to gain secure access to data, such as username and password combinations, public/private key combinations, and biometric data.

With all of these verification methods, a user may have to remember or utilize a distinct verification method for every service provider. Additionally, for organizations that maintain multiple service providers, each service provider must create, maintain, and update its own identity verification mechanisms. For large organizations with service providers belonging to different functional units, management of these disparate verification mechanisms may be problematic. Further, from the user's perspective, the complexity of keeping track of multiple identity verification mechanisms for different service providers may be undesirable.

As more and more data is stored remotely and access to that data through various services becomes increasingly important, it will become correspondingly important to accurately verify a user's identity in a way that ensures that data may only be accessed by appropriate users.

### SUMMARY OF THE DISCLOSURE

The present disclosure provides a method and apparatus for identity verification that substantially eliminates or reduces at least some of the disadvantages and problems associated with previous methods and systems.

According to one embodiment, a method for identity verification may include receiving one or more policies from a service provider, wherein the one or more policies relate to a plurality of attributes needed to access one or more resource provided by the service provider. The method may also include receiving a resource identification from a service provider, wherein the resource identification names a requested resource provided by the service provider and requested by a communication device. The method may also include identifying a resource policy from the one or more policies, wherein the resource policy is associated with the requested resource and identifies a set of required attributes needed to access the requested resource. Once it has identified the set of required attributes, the method may inform an attribute collection agent. The method may then receive an attribute report from the attribute collection agent, wherein the attribute report comprises a plurality of attribute values associated with the communication device and related to the set of required attributes. Once received, the method may then authenticate the attribute report. The method may then determine whether the plurality of attribute values satisfies the policy, and inform the service provider if the policy was satisfied.

Also provided is a system for identity verification that includes a database and a processor coupled to the database. The database is operable to store one or more policies, wherein the policies relate to a plurality of attributes needed to access one or more resources provided by a service provider. The processor is operable to: receive one or more policies from a service provider; receive a resource identification from a service provider; identify a resource policy from the one or more policies; identify a set of required attributes needed to access the requested resource; inform an attribute collection agent of the set of required attributes; receive an attribute report from the attribute collection agent; authenticate the attribute report; determine whether the plurality of attribute values satisfies the policy; and inform the service provider if the policy was satisfied.

Technical advantages of certain embodiments of the present disclosure include providing dedicated, verified, centralized, secure identity verification. More particularly, hosting policy-based verification based on authenticated attributes allows greater diversity of, and greater reliability on, attributes used for verification, better protecting the service provider. Centralizing the verification allows for dedication of service provider resource to its functional tasks rather than to identity verification. Further, centralization may allow effective management of multiple service provider environments while allowing individual service providers the flexibility to maintain the verification policies most appropriate to their resources. Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram of an identity verification system, in accordance with certain embodiments of the present disclosure;

FIG. 2 is a simplified block diagram illustrating various functional components of verification server, in accordance with certain embodiments of the present disclosure; and

FIG. 3 illustrates a flow chart of an example method for verifying the identity of a user of communication device, in accordance with certain embodiments of the present disclosure.

### DETAILED DESCRIPTION OF THE INVENTION

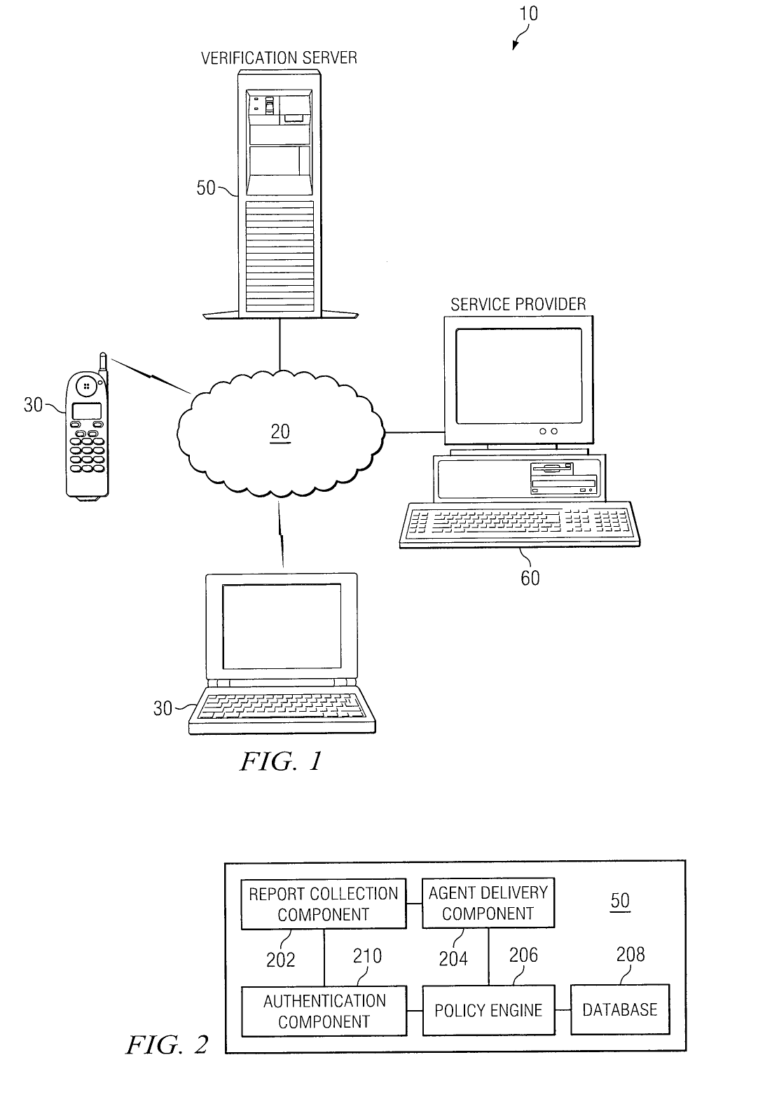

FIG. 1 is a simplified block diagram of an identity verification system 10, in accordance with certain embodiments of the present disclosure. According to the illustrated embodiment, identity verification system 10 includes communication network 20, communication devices 30, verification server 50, and service provider 60.

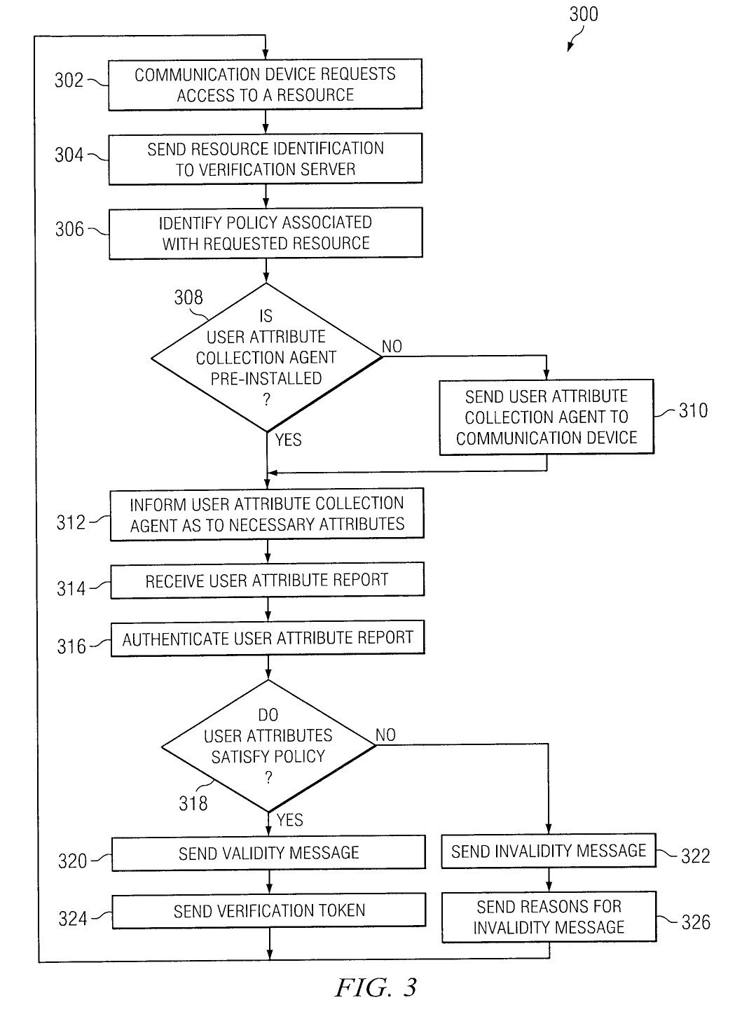

In general, the components of identity verification system 10 may use a set of attributes associated with communication device 30 to securely verify one or more requests for resources hosted by service provider 60. Communication device 30 may request access to a resource via communication network 20. Verification server 50 may receive and verify certain attributes associated with communication device 30, and then analyze those attributes to see if they satisfy the access policy for the requested resource. The policies stored on verification server 50 are described in more detail below with reference to FIGS. 2-3. The attributes received by verification server 50 may include data that does not change with a user's physical location or authentication procedure (“static data”), such as username/password, biometric data, or hardware key; or data that may change based on a user's physical location or authentication procedure (“dynamic data”), such as a user's current network, operating system or other software installed on communication device 30, and current time.

As illustrated, communication network 20 represents any network capable of transmitting audio and/or video telecommunication signals, data, and/or messages. In certain embodiments, communication network 20 may comprise all, or a portion of, a radio access network; a public switched telephone network (PSTN); a public or private data network; a local area network (LAN); a metropolitan area network (MAN); a wide area network (WAN); a local, regional, or global communication or computer network such as the Internet; a wireline or wireless network; an enterprise intranet; or any combination of the preceding. In operation, communication network 20 provides connectivity between components coupled to communication network 20 using any appropriate communication protocol. To facilitate the described communication capabilities, communication network 20 may include routers, hubs, switches, gateways, call controllers, and/or any other suitable components in any suitable form or arrangement. Additionally, communication network 20 may include any hardware and/or software configured to communicate information in the form of packets, cells, frames, segments or other portions of data. Although communication network 20 is illustrated as a single network, communication network 20 may comprise any number or configuration of networks. Moreover, certain embodiments of identity verification system 10 may include any number or configuration of communication networks 20.

Communication devices 30 may represent any suitable combination of hardware, software, and/or encoded logic to provide communication services to a user. Among other things, communication devices 30 may represent an information kiosk; telephone; cell phone; personal digital assistant (PDA); computer running telephony, e-mail, or other forms of messaging and/or communication software; or any other communication hardware, software, and/or encoded logic that supports communication of voice, video, text or other forms of data using identity verification system 10.

As illustrated, communication devices 30 include an attribute collection agent. In some embodiments, a user of communication device 30 may initiate a process to download the attribute collection agent from a designated server, e.g., verification server 50, prior to requesting access to services. In other embodiments, verification server 50 may send the attribute collection agent to communication device 30 for installation upon receiving a resource identification from service provider 60. In some embodiments, verification server 50 may deliver the attribute collection agent via an information delivery technology such as Java Web Start or ActiveX, via communication network 20.

Verification server 50 may represent a trusted, dedicated server that manages security policies and authenticates attributes. Verification server 50 may contain a database containing a number of policies defining a set of attribute values that must be met before a user of communication device 30 can have access to a resource of service provider 60. The policies stored on verification server 50 are described in more detail below with reference to FIGS. 2-3. Verification server 50 may receive an attribute report from communication device 30 identifying a plurality of attributes associated with communication device 30. After authenticating the attributes, verification server 50 may notify service provider 60 whether service provider 60 should provide the requested service to communication device 30. Verification server 50 is described in more detail below with reference to FIGS. 2-3.

Service provider 60 may generally represent any combination of hardware and software, including controlling logic, for providing one or more services to communication device 30. In particular embodiments, as an example only, service provider 60 may represent a centralized repository of documents, such as medical records. In other embodiments, as an example only, service provider 60 may represent an application service provider which provides access to particular applications, software or other media over a network. Such applications, software, or media may include, among other things, document readers, web browsers, or document editing software. As another example, service provider may also be an online networking website or an Email provider.

In operation, communication device 30 may request a resource from service provider 60 via communication network 20. Service provider may then provide a resource identification naming the requested resource to verification server 50 via communication network 20. Verification server 50 may contain a database containing a number of policies defining a set of attribute values that must be met before communication device 30 can have access to a resource of service provider 60. The policies stored on verification server 50 are described in more detail below with reference to FIGS. 2-3. Verification server 50 may receive an attribute report from an attribute collection agent, stored on communication device 30, identifying a plurality of attributes associated with communication device 30. After authenticating the attributes, verification server 50 may analyze the authenticated attributes to see if they satisfy the identified policy associated with the requested resource. Once analyzed, verification server 50 may notify service provider 60 whether service provider 60 should provide the requested service to communication device 30.

FIG. 2 is a simplified block diagram illustrating various functional components of verification server 50, in accordance with certain embodiments of the present disclosure. The illustrated verification server 50 may include report collection component 202, agent delivery component 204, policy engine 206, database 208, and authentication component 210. The various components of verification server 50 may be, in some embodiments, a software program stored on computer-readable media and executable by a processor of verification server 50. For clarity of description FIG. 1 depicts the components a separate modules. In some embodiments, the components may be stand-alone software programs. However, the components may also be a component or subroutine of a larger software program, or hard-coded into computer-readable media, and/or any hardware or software modules configured to perform the described functions.

Report collection component 202 may be configured to receive an attribute report from communication device 30. The attribute report may contain a plurality of static and dynamic attributes associated with communication device 30 and collected by the attribute collection agent, as described in more detail above with reference to FIG. 1. The attribute collection agent may compose the attribute report in response to input from agent delivery component 204.

Agent delivery component 204 may be configured to deliver an attribute collection agent to communication device 30. In some embodiments, after verification server 50 receives a resource identification from service provider 60, agent delivery component 204 may send the attribute collection agent to a communication device 30 that has not previously installed the agent. In some embodiments, communication device 30 may have already installed the attribute collection agent through other means. As described above with reference to FIG. 1, agent delivery component 204 may send the agent to communication device 30 with an information delivery technology such as Java Web Start or ActiveX. Additionally, in some embodiments, agent delivery component 204 maybe configured to inform the attribute collection agent which attributes should be collected and/or transmitted from communication device 30 for a given resource request. In some embodiments, the attribute collection agent may collect both static and dynamic information that accurately identifies information associated with communication device 30. These attributes may, if required, be gathered using trusted computing technologies in order to more reliably report the information associated with communication device 30 identity. These trusted computing technologies may include the use of a Trusted Platform Module (TPM) and/or Trusted Network Connect (TNC) to prove that the gathered attributes reflect the current state of communication device 30 and are not compromised by other programs in communication device 30 or during the transmission from communication device 30 to verification server 50. In other embodiments, the attribute collection agent may gather dynamic information associated with communication device 30, such as the operating system running on communication device 30, any other software installed or running on communication device 30, or the physical location of communication device 30 (as represented by the current network or GPS location of communication device 30 or any other suitable data). As an illustrative example, if a policy requires a user's biometric data, then agent delivery component 204 may inform the attribute collection agent, which in turn may request this data from communication device 30.

Database 208 may be configured to store one or more policies relating to the attributes needed to access the resources provided by service provider 60. A policy may include a set of required attribute values necessary to allow communication device 30 to access a resource provided by service provider 60. In some embodiments, a policy may include a set of statements relating one or more static and dynamic attribute(s) to an appropriate value for each attribute(s). These statements may be combined in an appropriate fashion to determine whether the communication device 30 have access to an identified resource. As an illustrative example, a policy may require communication device 30 to be connected to a certain communication network 20 and have a certain hardware key installed.

Policy engine 206 may be configured to identify a policy stored within database 208. In some embodiments, service provider 60 may send one or more policies to verification server 50 defining the access rules for the resources provided by service provider 60. These policies, as described above, may be stored in database 208. Once service provider 60 receives a request for access to a particular resource, service provider 60 may communicate that requested resource to verification server 50. This communication, referred to generally as a “resource identification,” identifies the requested resource to verification server 50. In some embodiments, service provider 60 may receive a plurality of requests from a plurality of communication devices 30, and combine the plurality of requested resources in a single message separately identifying the requested resources. In other embodiments, service provider 60 may send a separate message to verification server 50 for each requested resource. The communication to verification server 50 may take the form of any appropriate communication standard, including OpenID. In some embodiments, the resource identification may include additional information, such as the IP address or MAC address of communication device 30 so that verification server 50 may communicate directly with communication device 30.

In some embodiments, policy engine 206 may be further configured to communicate to agent delivery component 204 which attributes are to be collected for a given resource request based on a policy associated with that resource. A policy may include a set of required attribute values necessary to allow access to a resource named in the resource identification received from service provider 60. In some embodiments, a policy may include a set of statements relating one or more attribute(s) to an appropriate value for each attribute(s). These statements may be combined in an appropriate fashion to determine whether communication device 30 may have access to an identified resource

As an example only, a doctor using an informational kiosk may request access to a web page containing a patient's medical records from service provider 60. Service provider 60 may identify the requested resource to verification server 50. Verification server 50 may include, in database 208, a policy defining the attributes necessary to access the requested web page. That policy may, for instance, state that a user can have access to this particular web page only if (1) the user is a doctor associated with the patient and (2) the doctor is physically located in a particular hospital when attempting to access the resource. The attribute report received by report collection component 202 may include static and dynamic attributes sufficient to identify the user of communication device 30 as a doctor (e.g., username, biometric identification data, or card access data), and attributes sufficient to identify the user's location as within the hospital (e.g., the network used by communication device 30). If the collected attributes meet the attributes defined within the appropriate policy, then the policy is satisfied and verification server 50 may notify service provider 60 of the validity of the request. This situation is provided as an illustrative example only, and should not be read to limit the scope of this disclosure. For instance, in other embodiments, a policy may rely only on dynamic data, or only certain types of particularly trusted data, or access may be granted if any one (rather than all) of a set of conditions is satisfied.

In some embodiments, the policies resident on verification server 50 are configured to be able to be updated by service provider 60. Service provider 60 may determine, at any time, that a policy should be updated. Policy engine 206 may be further configured to receive a policy update and make the requested changes to the policy stored in database 208.

Authentication component 210 may be configured to authenticate the attribute report received at report collection component 202. In some embodiments, authentication component 210 may use trusted computing technologies, such as a Trusted Platform Module (TPM), to authenticate the attribute report. A TPM may be any security device that complies with the TPM specification published by the Trusted Computing Group. In some embodiments, a Trusted Platform Module (TPM) is installed on communication device 30 and used to record the state of communication device 30 (e.g., the installed hardware and their drivers, and the installed and running software) currently and at some points in the history of communication device 30. The recorded information within the TPM can not be modified by communication device 30. When necessary, such as when the attribute report is to be sent to report collection component 202, the TPM may generate a report of the current state of communication device 30 and sign it with the TPM's unique key. This report may, in some embodiments, be the source of some or all of the dynamic data included in the attribute report. When authentication component 210 receives the attribute report, it may verify the TPM's signature and thus have a high degree of confidence that the report was generated by TPM, the content of the report was not modified by other components, and the report is trustworthy.

In operation, the components of verification server 50 may communicate through any appropriate software or hardware mechanism, such as the operating system or an internal bus. The components function collectively as described in more detail below with reference to FIG. 3.

FIG. 3 illustrates a flow chart of an example method 300 for verifying the identity of a user of communication device 30, in accordance with certain embodiments of the present disclosure. Method 300 includes receiving an attribute report, authenticating the attribute report, receiving a resource identification, identifying a relevant policy, determining whether the attributes satisfy the policy, sending a validity message if the policy is satisfied, and sending an invalidity message if the policy is not satisfied.

According to one embodiment, method 300 preferably begins at step 302. Teachings of the present disclosure may be implemented in a variety of configurations of verification server 50. As such, the preferred initialization point for method 300 and the order of steps 302-326 comprising method 300 may depend on the implementation chosen. Additionally, the steps of method 300 may not be performed in any appropriate order other than the order illustrated.

At step 302, communication device 30 may request access to a resource of service provider 60 via communication network 20. After receiving the request, service provider 60 may, at step 304, send a resource identification to verification server 50 to identify the resource that communication device 30 is attempting to access. In some embodiments, service provider 60 may receive a plurality of requests from a plurality of communication devices 30, and combine the plurality of requested resources in a single message separately identifying the requested resources. In other embodiments, service provider 60 may send a separate message to verification server 50 for each requested resource. In some embodiments, the resource identification may include additional information, such as the IP address or MAC address of communication device 30, so that verification server 50 may communicate directly with communication device 30.

After receiving the resource identification at verification server 50, method 300 may proceed to step 306. At step 306, verification server 50 may identify a policy relevant to the resource identified by service provider 60. This identification may include identifying the attribute values necessary to access the named resource. After identifying the necessary attribute values, method 300 may proceed to step 308. At step 308, verification server 50 may contact communication device 30 to determine whether the attribute collection agent is pre-installed. If it is not, method 300 may proceed to step 310, wherein agent delivery component 204 of verification server 50 may send the attribute collection agent to communication device 30. After sending the attribute collection agent, method 300 may proceed to step 312. Method 300 may also proceed to step 312 if the attribute collection agent is pre-installed on communication device 30.

As noted below, the steps of method 300 may occur in any appropriate order (including concurrently), or may be combined. For instance, step 308 and step 306 may occur concurrently after verification server 50 receives the resource identification. In some configurations of identity verification system 10 it may be desirable to perform these steps in order so that the attribute collection agent may be configured as to which attributes should be collected in order to satisfy the policy identified in step 306 prior to being sent to communication device 30, as described in step 310. In other configurations, it may be desirable to maintain a non-specifically configured attribute collection agent to send to communication device 30. In such a configuration, it may be necessary to then notify the sent attribute collection agent as to which attributes should be collected in order to satisfy the policy identified in step 306. This step is illustrated separately as step 312.

After the notification, method 300 may proceed to step 314, wherein the attribute collection agent sends the necessary attributes in the form of an attribute report to report collection component 202 of verification server 50. Method 300 may then proceed to step 316. At step 316, the attribute report is authenticated by authentication component 210 of verification server 50 before proceeding to step 318. At step 318, policy engine 206 may analyze the attributes authenticated in step 316 to determine if they satisfy the policy identified in step 306. If the policy is not satisfied, method 300 may proceed to step 322, where verification server 50 sends service provider 60 an invalidity message indicating that communication device 30 should not have access to the requested resource before the method proceeds to step 326. If the authenticated attributes do satisfy the policy, then method 300 may proceed to step 320, where verification server 50 send service provider 60 a validity message that communication device 30 should have access to the requested resource.

After sending the validity message in step 320, method 300 may proceed to step 324. At step 324, verification server 50 or service provider 60 may send an electronic token to communication device 30, which communication device 30 may use to indicate, within a predetermined amount of time, that communication device 30 has been verified and may not need to be re-verified. As an illustrative example, service provider 60 may issue a digital certificate to communication device 30. Should communication device 30 need access to the same request within the next ten minutes (as an example only), communication device 30 may send the digital certificate along with the resource access request. The digital certificate may indicate that communication device 30 need not be re-verified. After issuing the electronic token to communication device 30, method 300 may return to step 302 to await another resource request.

After sending the invalidity message in step 322, method 300 may proceed to step 326. At step 326 service provider 60 may provide additional information to communication device 30 indicating why the resource request was denied. In some embodiments, the additional information may be included as part of the invalidity message sent to service provider 60 in step 322. After providing the additional information, method 300 may return to step 302 to await another resource request.

Although FIG. 3 discloses a particular number of steps to be taken with respect to method 300, method 300 may be executed with more or fewer steps than those depicted in FIG. 3. For instance, in some embodiments, verification server 50 may provide, after getting permission from the user of communication device 30, some of the gathered attributes to service provider 60 for more advanced verification purposes. In other embodiments, the chosen configuration of verification system 10 may make it undesirable to perform steps 324 or 326.

In addition, although FIG. 3 discloses a certain order of steps comprising method 300, the steps comprising method 300 may be completed in any suitable order. For example, in the embodiment of method 300 shown, verification server 50 determines whether communication device 30 has pre-installed the attribute collection agent after receiving the resource identification from service provider 60. However, this determination may be made at any appropriate time, or not at all. For example, communication device 30 may make multiple resource requests to one or more service provider(s) 60. Method 300 may only make this determination once.

Using the methods and systems disclosed herein, certain problems associated with verifying the identity of a user of communication device 30 may be improved, reduced, or eliminated. For example, the methods and system disclosed herein allow for identity verification through the authentication of trusted attributes and their application to resource policies.

What is claimed is:

1. A method for identity verification comprising:
receiving one or more policies from a service provider, the one or more policies relating to a plurality of static and dynamic attributes needed to access one or more resources provided by the service provider;
receiving a resource identification from the service provider, the resource identification identifying a requested resource provided by the service provider and requested by a communication device;
identifying a resource policy from the one or more policies, the resource policy associated with the requested resource and identifying a set of required static and dynamic attributes needed to access the requested resource;
informing an attribute collection agent of the set of required static and dynamic attributes;
receiving an attribute report from the attribute collection agent, the attribute report comprising a plurality of attribute values associated with the communication device and related to the set of required static and dynamic attributes;
authenticating the attribute report;
determining whether the plurality of attribute values satisfies the resource policy;
informing the service provider if the plurality of attribute values satisfies the resource policy.

2. The method of claim 1, wherein the resource identification also identifies the communication device.

3. The method of claim 1, further comprising sending the attribute collection agent to the communication device.

4. The method of claim 1, wherein the plurality of static and dynamic attributes comprises biometric data.

5. The method of claim 1, wherein the plurality of static and dynamic attributes comprises environment data associated with the communication device.

6. The method of claim 1, further comprising if the plurality of attribute values satisfies the resource policy, sending an electronic token to the communication device, the electronic token allowing the communication device to avoid identity verification for the requested resource within a predetermined amount of time.

7. The method of claim 1, further comprising if the plurality of attribute values does not satisfy the resource policy, providing additional information to the communication device indicating the reasons for denial of access to the requested resource.

8. The method of claim 1, further comprising:
receiving an update to the resource policy from the service provider; and
updating the resource policy.

9. A method for identity verification comprising:
sending one or more policies to a verification server, the one or more policies relating to a plurality of static and dynamic attributes needed to access one or more resources provided by the service provider;
receiving a request for access to a requested resource from a communication device;
sending a resource identification to the verification server, the resource identification identifying the requested resource;
receiving a message from the verification server indicating whether the communication device has satisfied a resource policy, the resource policy having been selected by the verification server based at least on the resource identification;
if the message indicates that the communication device satisfied the resource policy, granting access to the communication device; and
if the message indicates that the communication device did not satisfy the resource policy, denying access to the communication device.

10. The method of claim 9, wherein granting access to the communication device further comprises sending a verification token to the communication device, the electronic token allowing the communication device to avoid identity verification for the requested resource within a predetermined amount of time.

11. The method of claim 9, wherein denying access to the communication device further comprises providing additional information to the communication device indicating the reasons for denial of access to the requested resource.

12. The method of claim 9, wherein the resource identification also identifies the communication device.

13. A system for identity verification comprising:
a database operable to store one or more policies, wherein the one or more policies relate to a plurality of static and dynamic attributes needed to access one or more resources provided by a service provider;
a processor coupled to the database and operable to:
receive the one or more policies from the service provider;
receive a resource identification from a service provider, the resource identification identifying a requested resource provided by the service provider and requested by a communication device;
identify a resource policy from the one or more policies, the resource policy associated with the requested resource and identifying a set of required static and dynamic attributes needed to access the requested resource;
inform an attribute collection agent of the set of required static and dynamic attributes;
receive an attribute report from the attribute collection agent, the attribute report comprising a plurality of attribute values associated with the communication device and related to the set of required static and dynamic attributes;
authenticate the attribute report;
determine whether the plurality of attribute values satisfies the resource policy;
inform the service provider if the plurality of attribute values satisfies the resource policy.

14. The system of claim 13, wherein the resource identification also identifies the communication device.

15. The system of claim 13, further comprising sending the attribute collection agent to the communication device.

16. The system of claim 13, wherein the plurality of static and dynamic attributes comprises biometric data.

17. The system of claim 13, wherein the plurality of static and dynamic attributes comprises environment data associated with the communication device.

18. The system of claim 13, wherein the processor is further operable to if the plurality of attribute values satisfies the resource policy, send an electronic token to the communication device, the electronic token allowing the communication device to avoid identity verification for the requested resource within a predetermined amount of time.

19. The system of claim 13, wherein the processor is further operable to if the plurality of attribute values does not satisfy the resource policy, provide additional information to the communication device indicating the reasons for denial of access to the requested resource.

20. The system of claim 13, wherein the processor is further operable to:
receive an update to the resource policy from the service provider; and
update the resource policy.
